(19) United States
(12) Patent Application Publication
(10) Pub. No.: US 2026/0364790 A1
(43) Pub. Date: Nov. 19, 2026

(54) DYNAMIC ADAPTIVE CONTROL METHOD FOR ROBOTIC MANIPULATOR UNDER TIME-VARYING MECHANISM CONSTRAINTS VIA RADIAL BASIS FUNCTION NETWORK

(71) Applicant: CHONGQING UNIVERSITY OF POSTS AND TELECOMMUNICATIONS, Chongqing (CN)

(72) Inventors: JIUFEI LUO, Chongqing (CN); XIAOLIN ZHENG, Chongqing (CN); DENGHUA ZHENG, Chongqing (CN); XIANFU WANG, Chongqing (CN); SHENG LU, Chongqing (CN); AIJUN YIN, Chongqing (CN); YUNFEI TAN, Chongqing (CN); ZHIBIN LI, Chongqing (CN); QIONG HUANG, Chongqing (CN)

(21) Appl. No.: 19/682,204

(22) Filed: May 19, 2026

Related U.S. Application Data
(63) Continuation of application No. PCT/CN2026/081579, filed on Mar. 5, 2026.

(30) Foreign Application Priority Data
May 13, 2025 (CN) 202510613191.7

(51) Int. Cl. B25J 9/16

(52) U.S. Cl. CPC B25J 9/163; B25J 9/1651; B25J 9/1664; B25J 9/1674

(57) ABSTRACT

A dynamic adaptive control method for a robotic manipulator under time-varying mechanism constraints via a radial basis function (RBF) network includes constructing a robotic manipulator dynamics model, determining a system prescribed-time convergence standard, defining a trajectory tracking error in combination with a joint motion reference trajectory of the robotic manipulator, and constructing a stable robust control law of a nominal dynamics model under a prescribed time based on a dynamics nominal model. The present disclosure solves a problem of uncontrollable convergence time of a traditional method. The present disclosure adopts an RBF network to dynamically approximate comprehensive disturbances, updates network weights online via an adaptive law of a time-varying gain, significantly improves an anti-interference capability, combines a model-driven method and a data-driven method, and achieves more precise and low-latency trajectory tracking control via a dynamics model decoupling and a feedforward compensation strategy.

### CROSS-REFERENCE TO RELATED APPLICATIONS

This application is a continuation of PCT/CN2026/081579, filed on Mar. 5, 2026 and claims priority of Chinese Patent Application No. 202510613191.7, filed on May 13, 2025, the entire contents of which are incorporated herein by reference.

### TECHNICAL FIELD

The present disclosure belongs to the field of robot technology control, and particularly relates to a dynamic adaptive control method for a robotic manipulator under time-varying mechanism constraints via a radial basis function (RBF) network.

### BACKGROUND

Robust control of an intelligent agent serves as one of core research directions in the field of intelligent manufacturing. As a core execution unit, a robotic manipulator is widely applied to high-precision operation scenarios such as precision assembly, logistics handling, and welding. Currently used control methods mainly include: proportional-derivative (PD) feedback control based on an exact dynamics model, which, although capable of achieving precise tracking performance of the robotic manipulator, exhibits significantly degraded control performance in face of dynamic unmodeled disturbances; and a sliding mode control method, which enables a system state to converge within an asymptotic time by designing a sliding mode surface, and although exhibiting good robustness against external disturbances and parameter uncertainties, has an inherent defect that a convergence time cannot be precisely guaranteed. In terms of current traditional control methods, the robotic manipulator faces the following key challenges during an actual operation process: unmodeled dynamics and parameter uncertainties, external disturbance rejection, and convergence speed and time constraints.

Compared with related art, although a radial basis function (RBF) network is capable of approximating unknown nonlinearities, a traditional weight update law has a slow convergence speed and lacks a time constraint mechanism; an existing time-varying gain method (such as terminal sliding mode) can achieve finite-time convergence, but requires a known disturbance upper bound and has a singularity problem; and a method combining a nominal model and a disturbance observer (such as active disturbance rejection control, ADRC) requires complex parameter tuning, and engineering practicality thereof is limited.

### SUMMARY

To effectively solve a precise control problem of a robotic manipulator in a complex dynamic environment, and to provide a reliable solution for scenarios such as intelligent manufacturing and industrial automation requiring a millimeter-level response and synchronous control, the present disclosure provides a dynamic adaptive control method for a robotic manipulator under time-varying mechanism constraints via a radial basis function (RBF) network, including constructing a robotic manipulator dynamics model, determining a system prescribed-time convergence standard, defining a trajectory tracking error in combination with a joint motion reference trajectory of the robotic manipulator, and constructing a stable robust control law of a nominal dynamics model under a prescribed time based on a dynamics nominal model, in which an RBF is selected, and an RBF network adaptive control law under the prescribed time is designed to dynamically fit a comprehensive nonlinear disturbance term in the system RBF network.

In a further aspect, the RBF network dynamic adaptive control law under the prescribed time is expressed as:

τ_{Total}=M₀(q)(\ddot{q}_{d}−kᵥ\dot{η}−kₚη)+C₀(q,\dot{q})\dot{q}+G₀(q)−\ddot{f}(q,\dot{q},\ddot{q})
where τ_{Total} represents a dynamic adaptive control law under the prescribed time of the RBF network RBF network; M₀(q) is a nominal inertia matrix of a robotic manipulator system, q represents an actual joint angular position vector of the robotic manipulator system; \ddot{q}_{d} represents a desired acceleration reference trajectory of the robotic manipulator system; kᵥ represents a second designed control gain matrix; \dot{η} represents a joint velocity tracking error scaled based on a time-varying gain function; kₚ represents a first designed control gain matrix; η represents a joint angular tracking error signal scaled based on a time-varying gain function; C₀(q,\dot{q}) is a nominal Coriolis force matrix of the robotic manipulator system; \dot{q} represents an actual joint velocity vector of the robotic manipulator system; G₀(q) is a nominal gravity vector of the robotic manipulator system; and \hat{f}(q,\dot{q},\ddot{q}) is a real-time estimated output value of the RBF for a comprehensive nonlinear disturbance term.

In a further aspect, the real-time estimated output value \hat{f}(q,\dot{q},\ddot{q}) of the RBF for the comprehensive nonlinear disturbance term is expressed as:

\hat{f}(q,\dot{q},\ddot{q})=ŵ^{T}h(x)
where ŵ is an online estimated value of a weight of the RBF network; h(x)=[h₁(x), . . . , hₘ(x)]^{T} is an output vector of an RBF, x=[q^{T},q̅^{T},q̅^{T}]^{T} represents an input state vector of the RBF network, q represents a current joint angular position vector of the robotic manipulator system, \dot{q} represents a current joint motion velocity vector of the robotic manipulator system, \ddot{q} represents a current joint motion acceleration vector of the robotic manipulator system, and m represents a number of nodes of a hidden layer of the RBF network.

In a further aspect, when calculating the RBF network dynamic adaptive control law under the prescribed time, an approximation error of the RBF network for a comprehensive nonlinear disturbance term is less than or equal to a supremum of the approximation error of the RBF network for the comprehensive nonlinear disturbance term, and the approximation error of the RBF network for the comprehensive nonlinear disturbance term is:

σ(x)=f(q,\dot{q},\ddot{q})−w*^{T}h(x)
where σ(x) is an approximation error of the RBF network for the comprehensive nonlinear disturbance term; f(q,\dot{q},\ddot{q}) is the comprehensive nonlinear disturbance term, expressed as f(q,\dot{q},\ddot{q})=ΔM\dot{q}+ΔC\dot{q}+ΔG+d, ΔM represents an inertia parameter uncertainty of the robotic manipulator system, ΔC represents a Coriolis force matrix modeling error of the robotic manipulator system, ΔG represents a gravity compensation residual of the robotic manipulator system, and d is an unknown external environment disturbance vector; and w* represents an ideal weight of the RBF network.

In a further aspect, an adaptive update law of the online estimated value w of the weight of the RBF network is:

ŵ=γμ(t)h(x)X^{T}PB
wherein γ is an adaptive learning rate; μ(t) is a time-varying gain function; h(x)=[h₁(x), . . . , hₘ(x)]^{T} is an output vector of an RBF; X=[η,\dot{η}]^{T} is an error state vector, η represents a joint angular tracking error scaled based on the time-varying gain function, and \dot{η} represents a joint velocity tracking error scaled based on the time-varying gain function; P is a solution matrix of a Lyapunov function; and B represents an inertia matrix.

In a further aspect, calculating the error state vector includes:

$$\begin{matrix}η ( t ) = μ ( t ) e ( t ) \\ \dot{η} ( t ) = μ ( t ) \dot{e} ( t ) + \frac{\dot{μ} ( t )}{μ ( t )} η ( t )\end{matrix}$$

wherein η(t) is a joint angular tracking error scaled based on the time-varying gain function at a moment t, and e(t) is an error between an actual joint angular trajectory at the moment t and a desired joint angular trajectory at the moment t, \dot{η}(t) is a joint velocity tracking error scaled based on the time-varying gain function at the moment t; and ė(t) is a difference between an actual joint velocity trajectory at the moment t and a desired joint velocity trajectory at the moment t, and \dot{μ}(t) is a derivative of a time-varying gain function with respect to time at the moment t.

In a further aspect, a solution matrix P of a Lyapunov function satisfies the following conditions:

A^{T}P+PA=−Q
wherein

$$A = [ \begin{matrix}0 & {I}_{n} \\ - {k}_{p} & - {k}_{v}\end{matrix} ]$$

represents a designed control gain parameter matrix, Iₙ represents an identity matrix with a dimension of n×n, n is a degree of freedom of the robotic manipulator system, and Q represents a positive definite symmetric matrix.

In a further aspect, a first designed control gain matrix is expressed as

$${k}_{p} = [ \begin{matrix}{α}^{2} & 0 \\ 0 & {α}^{2}\end{matrix} ] ;$$

and a second designed control gain matrix is expressed as

$${k}_{v} = [ \begin{matrix}2 α & 0 \\ 0 & 2 α\end{matrix} ] ,$$

where α is a designed positive constant.

In a further aspect, when a preset convergence time is T, a system Lyapunov function is bounded on a region [0,T), and a prescribed-time convergence criterion is:

$$\dot{V} ( t ) \leq - 2 k μ ( t ) V ( t ) + \frac{μ ( t )}{4 θ} {d ( t )}^{2}$$

where \dot{V}(t) represents a derivative of a system Lyapunov function with respect to time; k, θ is a positive constant, V(t) represents the system Lyapunov function; and d(t) represents an unknown disturbance of the system.

In a further aspect, a dynamics model of a robotic manipulator with n degrees of freedom is expressed as:

M(q)\ddot{q}+C(q,\dot{q})\dot{q}+G(q)=τ+d
where M(q)∈ [symbol] ^{n×n} is a positive definite inertia matrix; C(q,\dot{q})∈ [symbol] ^{n×n} is a Coriolis force matrix; G(q)∈ [symbol] ⁿ is a gravity vector; dis an unknown external environment disturbance vector; τ∈ [symbol] ⁿ is an input torque of a joint, q represents a current joint angular position vector of the robotic manipulator system, \dot{q} represents a current joint motion velocity vector of the robotic manipulator system, and \ddot{q} represents a current joint motion acceleration vector of the robotic manipulator system.

Aiming at unmodeled dynamics and external disturbances faced by a robotic manipulator in an actual working condition, the present disclosure provides an RBF network architecture based on a prescribed time. By introducing a time-varying gain mechanism, the architecture achieves the following technical breakthroughs: precise time convergence control, a designed control algorithm ensures that a system nonlinear model approximation error achieves global convergence within a user preset time, which solves a problem that a convergence time of a traditional method is uncontrollable; intelligent disturbance compensation, adopting an RBF network to dynamically approximate comprehensive disturbances, and online updating network weights via an adaptive law of a time-varying gain, thereby significantly improving an anti-interference capability; and innovatively combining a model-driven method and a data-driven method to achieve more precise and low-latency trajectory tracking control through a dynamics model decoupling and a feedforward compensation strategy. Compared with related art, the provided RBF network dynamic adaptive control of the prescribed time achieves precise convergence within a user prescribed time, and the anti-interference capability is significantly enhanced.

### BRIEF DESCRIPTION OF THE DRAWINGS

FIG. 1 is a flow block diagram of a dynamic adaptive control method for a robotic manipulator under time-varying mechanism constraints via a radial basis function (RBF) network according to the present disclosure;

FIG. 2 is a Simulink framework diagram of dynamic adaptive control through the RBF network according to the present disclosure;

FIG. 3 is a schematic diagram illustrating that an actual angular trajectory of a robotic manipulator joint 1 and a robotic manipulator joint 2 tracks a desired angular trajectory when a prescribed time is 1 s according to the present disclosure;

FIG. 4 is a schematic diagram illustrating that an actual velocity trajectory of the robotic manipulator joint 1 and the robotic manipulator joint 2 tracks a desired velocity trajectory when the prescribed time is 1 s according to the present disclosure;

FIG. 5 is a schematic diagram of control inputs of the robotic manipulator joint 1 and the robotic manipulator joint 2 when the prescribed time is 1 s according to the present disclosure;

FIG. 6 is a schematic diagram of RBF approximation nonlinear disturbances of the robotic manipulator joint 1 and the robotic manipulator joint 2 when the prescribed time is 1 s according to the present disclosure; and

FIG. 7 is a schematic diagram illustrating that the actual angular trajectory of the robotic manipulator joint 1 and the robotic manipulator joint 2 tracks the desired angular trajectory when the prescribed time is 0.5 s according to the present disclosure.

### DETAILED DESCRIPTION

Reference will now be made in detail to the accompanying drawings of the embodiments of the present disclosure, and the technical solutions in the embodiments of the present disclosure will be clearly and completely described. Apparently, the described embodiments are merely a part of the embodiments of the present disclosure, but not all of the embodiments. Based on the embodiments in the present disclosure, all other embodiments obtained by a person of ordinary skill in the art without creative efforts shall fall within the protection scope of the present disclosure.

The present disclosure provides a dynamic adaptive control method for a robotic manipulator under time-varying mechanism constraints via a radial basis function (RBF) network, including: constructing a robotic manipulator dynamics model, determining a system prescribed-time convergence standard, defining a trajectory tracking error in combination with a joint motion reference trajectory of the robotic manipulator, and constructing a stable robust control law of a nominal dynamics model under a prescribed time based on a dynamics nominal model; in which an RBF is selected, and an RBF network adaptive control law under the prescribed time is designed to dynamically fit a comprehensive nonlinear disturbance term in the system.

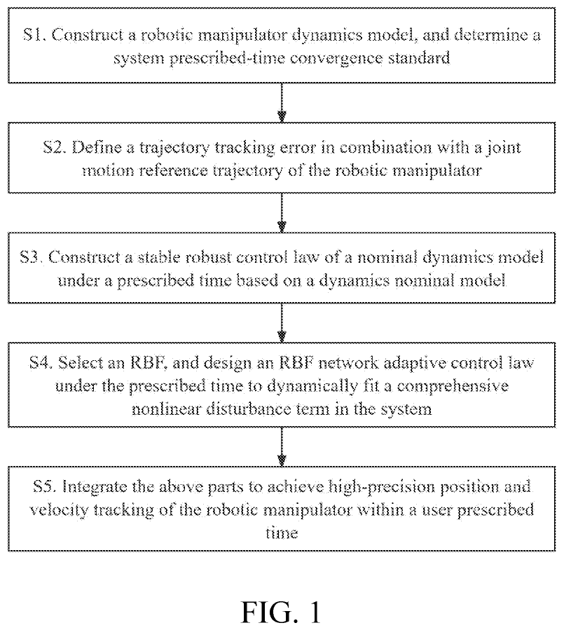

The embodiment provides a dynamic adaptive control method for a robotic manipulator under time-varying mechanism constraints via an RBF network. As shown in FIG. 1, the method includes the following contents:

In S1: a robotic manipulator dynamics model is constructed, and a system prescribed-time convergence standard is determined.

The embodiment considers a robotic manipulator with n degrees of freedom, and a dynamics model thereof is expressed as:

M(q)\ddot{q}+C(q,\dot{q})\dot{q}+G(q)=τ+d
where M(q)∈ [symbol] ^{n×n} is a positive definite inertia matrix; C(q,\dot{q})∈ [symbol] ^{n×n} is a Coriolis force matrix (including a centrifugal force and a Coriolis force); G(q)∈ [symbol] ⁿ is a gravity vector; d is an unknown external environment disturbance vector; τ∈ [symbol] ⁿ is an input torque of a joint, i.e., a control input vector, q represents a current joint angular position vector of the robotic manipulator system, \dot{q} represents a current joint motion velocity vector of the robotic manipulator system, and \ddot{q} represents a current joint motion acceleration vector of the robotic manipulator system.

When a preset convergence time is T, that is, an actual control and a desired control of the robotic manipulator achieve consistency within the convergence time at the latest, a system Lyapunov function is bounded on a region [0,T), and a prescribed-time convergence criterion is:

$$\dot{V} ( t ) \leq - 2 k μ ( t ) V ( t ) + \frac{μ ( t )}{4 θ} {d ( t )}^{2}$$

where \dot{V}(t) represents a derivative of a system Lyapunov function with respect to time; k and θ are positive constants greater than 0, μ(t) represents a time-varying gain function, and V (t) represents the system Lyapunov function; and d(t) represents an unknown disturbance of the system.

Furthermore, considering the time-varying gain function μ(t), if there exists a smooth function v: [0,T)→[0,+∞) satisfying an inequality:

$$\dot{V} ( t ) \leq - 2 k μ ( t ) V ( t ) + \frac{μ ( t )}{4 θ} {d ( t )}^{2} ;$$

For the case where d(t) is an unknown disturbance, and k and θ>0, are positive constants, and V(t) is bounded on a time interval [0,T), i.e.,

$${lim}_{t \to {T}^{-}} V ( i ) = 0 .$$

When a system control process time t approaches a preset convergence time T, i.e., (t→T⁻), the time-varying gain function μ(t)→∞ tends to infinity. To prevent an unbounded gain, an expression of the time-varying gain function μ(t) is further expressed as:

$$μ ( t ) = \{ \begin{matrix}min [ {( \frac{T}{T - t} )}^{( p + β )} , {μ}_{max} ] , & t ∈ [ 0 , δ T ] \\ {μ}_{max} [ 1 - \frac{t - δ T}{( 1 - δ ) T} ] , & t ∈ [ δ T , T ] \\ {μ}_{min} , & t ∈ [ T , + ∞ )\end{matrix}$$

where t represents time in a control process of the robotic manipulator system, T represents a convergence time prescribed by a user, 8 represents a coefficient of a safe transition interval, μₘₐₓ represents an upper limit for preventing an unbounded growth of the time-varying gain function, μₘᵢₙ represents a lower limit of a stable time-varying gain, P represents an order of the robotic manipulator system, and β represents a positive design parameter.

A dynamics model of the robotic manipulator system includes a nominal part and an unmodeled part (an unknown part), which is specifically described as:

ΔM=M₀−M

ΔC=C₀−C

ΔG=G₀−G
where M₀(q)∈ [symbol] ^{n×n}, C₀(q,\dot{q})∈ [symbol] ^{n×n}, and G₀(q)∈ [symbol] ^{n×n} and respectively represent a nominal inertia matrix, a nominal Coriolis force matrix (including a Coriolis force and a centrifugal force), and a nominal gravity vector of the robotic manipulator system, ΔM, ΔC, and ΔG and respectively represent an inertia parameter uncertainty, a Coriolis force matrix uncertainty, and a gravity compensation residual of the robotic manipulator system, M(q) is the positive definite inertia matrix of the robotic manipulator system; C(q,\dot{q}) is the Coriolis force matrix of the robotic manipulator system; and G(q) is the gravity vector of the robotic manipulator system.

Based on clarifying dynamics characteristics, the following assumptions are introduced:
Assumption 1: for any time ∀t∈[0,T), a reference trajectory and derivatives thereof of the system are continuous and bounded, namely:

∥q_{d}(t)∥≤q̅_{d},∥\dot{q}_{d}(t)∥≤v̅_{d},∥\ddot{q}_{d}(t)∥≤ā_{d}
where q_{d}(t), \dot{q}_{d}(t), \ddot{q}_{d}(t) and respectively represent a desired joint angular, velocity, and acceleration trajectory, q̅_{d}, v̅_{d}, ā_{d} are known positive constants, and ∥⋅∥ represents a 2-norm.

The unknown disturbance d(t) is bounded, namely:

∥d(t)∥≤d,∀t∈̅[0,T)
where d̅ represents an unknown but bounded positive constant.

In S2: a trajectory tracking error is defined.

Based on the joint motion reference trajectory of the robotic manipulator, a joint angular tracking error e(t) and a joint velocity tracking error ė(t) of the robotic manipulator are respectively defined as:

e(t)=q(t)−q_{d}(t)∈Rⁿ

ė(t)=\dot{q}(t)−\dot{q}_{d}(t)∈Rⁿ
where q(t)∈Rⁿ represents an actual joint angular position vector at a moment t, q_{d}(t)∈Rⁿ represents a desired joint angular trajectory at the moment t, \dot{q}(t)∈Rⁿ represents an actual joint velocity vector at the moment t, and \dot{q}_{d}(t)∈Rⁿ represents a desired joint velocity trajectory at the moment t.

Based on a prescribed-time control theory, a tracking error is dynamically scaled according to the time-varying gain function μ(t), therefore a scaled joint angular tracking error signal η(t) and a scaled velocity tracking error signal \dot{η}(t) are respectively expressed as:

$$η ( t ) = μ ( t ) e ( t )$$

$$\dot{η} ( t ) = μ ( t ) \dot{e} ( t ) + \frac{\dot{μ} ( t )}{μ ( t )} η ( t )$$

where μ(t) represents a time-varying scaling function, which is expressed as

$$μ ( t ) = {( \frac{T}{T - t} )}^{( p + β )} ,$$

and a derivative of the time-varying gain function with respect to time \dot{μ}(t) is expressed as:

$$\dot{μ} ( t ) = \frac{p + β}{T - t} {( \frac{T}{T - t} )}^{p + β} = \frac{p + β}{T - t} μ ( t )$$

where p represents an order of the robotic manipulator system, and β represents a positive design parameter.

In S3: a stable robust control law of a nominal dynamics model is constructed under a prescribed time based on a dynamics nominal model.

By substituting the nominal model described in step 1 into an original dynamics model, it is expressed as:

M₀(q)\ddot{q}+C₀(q,\dot{q})\dot{q}+G₀(q)=τ+f(q,\dot{q},\ddot{q})
where f(q,\dot{q},\ddot{q})=ΔM\ddot{q}+ΔC\dot{q}+ΔG+d represents a comprehensive nonlinear disturbance term, which includes unmodeled dynamics and the external disturbance d.

Based on the nominal dynamics model, a prescribed-time control law under a condition that the comprehensive nonlinear disturbance term is known is:

τ₁=M₀(q)(\ddot{q}_{d}−kᵥ\dot{η}−kₚη)+C₀(q,\dot{q})\dot{q}+G₀(q)−f(q,\dot{q},\ddot{q})
where τ₁∈ [symbol] ⁿ represents a joint control input vector based on the nominal dynamics model, M₀(q)∈ [symbol] ^{n×n}, C₀(q,\dot{q})∈ [symbol] ^{n×n}, and G₀(q)∈ [symbol] ^{n×n} and respectively represent a nominal inertia matrix, a nominal Coriolis force matrix (including a Coriolis force and a centrifugal force), and a nominal gravity vector of the robotic manipulator system, \ddot{q}_{d}∈Rⁿ represents a desired acceleration reference trajectory, \dot{q}∈Rⁿ represents an actual joint velocity vector, kₚ represents a first design control gain matrix, which is expressed as

$${k}_{p} = [ \begin{matrix}{α}^{2} & 0 \\ 0 & {α}^{2}\end{matrix} ] ,$$

α>0 represents a positive constant, kᵥ represents a second design control gain matrix, which is expressed as

$${k}_{v} = [ \begin{matrix}2 α & 0 \\ 0 & 2 α\end{matrix} ] ,$$

f(q,\dot{q},\ddot{q}) is a comprehensive nonlinear disturbance term, which is expressed as f(q,\dot{q},\ddot{q})=ΔM\dot{q}+ΔC\dot{q}+ΔG+d, ΔM, ΔC, and ΔG respectively represent an inertia parameter uncertainty, a Coriolis force matrix modeling error, and a gravity compensation residual of the robotic manipulator system, d is expressed as an unknown disturbance but bounded, and n and n respectively represent a joint angular tracking error signal and a joint velocity tracking error signal scaled based on the time-varying gain function.

In S4: an RBF is selected, and an RBF network adaptive control law is designed under a prescribed time to dynamically fit the comprehensive nonlinear disturbance in the system.

Since the comprehensive nonlinear disturbance term f(q,\dot{q},\ddot{q})∈ [symbol] ⁿ is often unknown in an actual engineering, approximation and compensation performed by using an RBF network estimator are expressed as:

\hat{f}(q,\dot{q},\ddot{q})=\ddot{w}^{T}h(x)
where x=[q^{T}, \dot{q}^{T},\ddot{q}^{T}]^{T}∈R³ⁿ represents an input state vector, \hat{f}(q,\dot{q},\ddot{q})− [symbol] ⁿ represents a real-time estimated output value vector of the RBF for the comprehensive nonlinear disturbance term, ŵ∈R^{m×n} is an online estimation value of an RBF network weight, h(x)=[h₁(x), . . . , hₘ(x)]^{T}∈ [symbol] ^{m} is an output vector of a Gaussian RBF, and each Gaussian basis function is expressed as:

$${h}_{i} ( x ) = exp ( - \frac{{‖ x - {c}_{i} ‖}^{2}}{{b}_{i}^{2}} ) , i = 1 , 2 , … , m$$

where cᵢ∈ [symbol] ³ⁿ and bᵢ>0 respectively represent a center vector and a width parameter of an ith RBF, and m represents a node number of a hidden layer.

Based on a universal approximation theory of the RBF network, for any given approximation accuracy ε>0 and an unknown comprehensive nonlinear disturbance term f(q,\dot{q},\ddot{q}): R³ⁿ→Rⁿ, there exists an ideal weight matrix w*∈ [symbol] ^{m×n} such that:

$${sup}_{x ∈ X} ‖ f ( x ) - {w}^{* T} h ( x ) ‖ \leq ε$$

wherein X⊂ [symbol] ³ⁿ is a compact set of a system state space, and an ideal weight w* is determined by a minimization maximum approximation error criterion as

$$w *= {argmin}_{w ∈ {ℝ}^{m \times n}} {sup}_{x ∈ \hat{X}} \{ ‖ f ( \cdot ) - {\hat{w}}^{T} h ( x ) ‖ \} .$$

An approximation error of the RBF network for the comprehensive nonlinear disturbance term is defined as:

σ(x)=f(q,\dot{q},\ddot{q})−w*^{T}h(x)
wherein σ(x)∈Rⁿ is a comprehensive nonlinear disturbance term approximation error vector, w*^{T}h(x) represents an optimal network output, and there exists a positive constant σ₀ such that:

∥σ(x)∥≤σ₀,∀x∈X
where an upper bound σ₀ is defined as

$${σ}_{0} = {sup}_{x ∈ x} ‖ f ( \cdot ) - {w}^{* T} h ( x ) ‖ .$$

In summary, the RBF dynamic network adaptive control law under the prescribed time is expressed as:

τ_{Total}=M₀(q)(\ddot{q}_{d}−kₚ\dot{η}−kₚη)+C₀(q,\dot{q})\dot{q}+G₀(q)−\hat{f}(q,\dot{q},\ddot{q})
where \hat{f}(q,\dot{q},\ddot{q})∈ [symbol] ₙ is the real-time estimated output value of the RBF for the comprehensive nonlinear disturbance term, which is expressed as \hat{f}(q,\dot{q},\ddot{q})=ŵ^{T}h(x), and ŵ∈R^{m×n} is an online estimation value of the RBF network weight.

By substituting the adaptive control law into the original dynamics model of the robotic manipulator, a following closed-loop system characteristic is obtained:

\dot{η}+kᵥ\dot{η}+kₚη=M₀⁻¹(q)(f(q,\dot{q},\ddot{q})−\hat{f}(q,\dot{q},\ddot{q}))
where a left side of an equation is an ideal second-order error dynamics, and a right side of the equation is a network approximation residual.

The above equation is converted into an error state space matrix form as (i.e., an update velocity of the scaled joint angular and velocity errors):

X=AX+B(σ(x)−\tilde{w}^{T}h(x))
where X=[η,\dot{η}]^{T}∈R²ⁿ is an error state vector,

$$A = [ \begin{matrix}0 & {I}_{n} \\ - {k}_{p} & - {k}_{v}\end{matrix} ] ∈ {R}^{2 n < 2 n}$$

represents a design control gain parameter matrix, Iₙ represents a n×n-dimensional identity

$$B = [ \begin{matrix}0 \\ {M}_{0}^{- 1} ( q )\end{matrix} ] ∈ {ℝ}^{2 n \times n}$$

represents an inertia matrix, Mₒ(q) represents the nominal inertia matrix of the robotic manipulator system, \tilde{w}=ŵ−w*∈ [symbol] ^{m×n} represents a weight estimation error matrix, and σ(x)=f(q,\dot{q},\ddot{q})−w*^{T}h(x)∈Rⁿ is an RBF network bounded approximation error.

Based on a Lyapunov stability theory and the time-varying gain function μ(t), the network weight adaptive update law under the prescribed time is designed as:

ŵ=γμ(t)h(x)X^{T}PB
where \dot{ŵ} represents the RBF network weight adaptive update law, γ>0 represents an adaptive learning rate; P=P^{T}>0 represents a solution matrix of a Lyapunov function, satisfying A^{T}P+PA=−Q(Q [symbol] 0), Q is a positive definite symmetric matrix used for specifying a system convergence performance, and Q [symbol] 0 represents that Q is a positive definite matrix.

In S5: the above parts are integrated to achieve high-precision position and velocity tracking of the robotic manipulator within a user prescribed time.

Considering a fully actuated system of an n-degree-of-freedom robotic manipulator, with unmodeled dynamics and dynamic external disturbances existing, given reference trajectories of a joint rotation angle q_{d} and/or a joint angular velocity \dot{q}_{d} of the robotic manipulator, a stable tracking control within a user defined time Tis achieved via a following controller, and a control law thereof is expressed as:

$$\{ \begin{matrix}{τ}_{Total} = {M}_{0} ( q ) ( {\ddot{q}}_{d} - {k}_{v} \dot{η} - {k}_{p} η ) + {C}_{0} ( q , \dot{q} ) \dot{q} + {G}_{0} ( q ) - \hat{f} ( q , \dot{q} , \ddot{q} ) \\ \hat{f} ( q , \dot{q} , \ddot{q} ) = \hat{w} \cdot h ( x ) \\ \dot{\hat{w}} = γμ ( t ) h ( x ) X \cdot PB\end{matrix} .$$

Based on the above control law, tracking control of a joint angular and a joint velocity of the robotic manipulator within a user prescribed time is finally achieved.

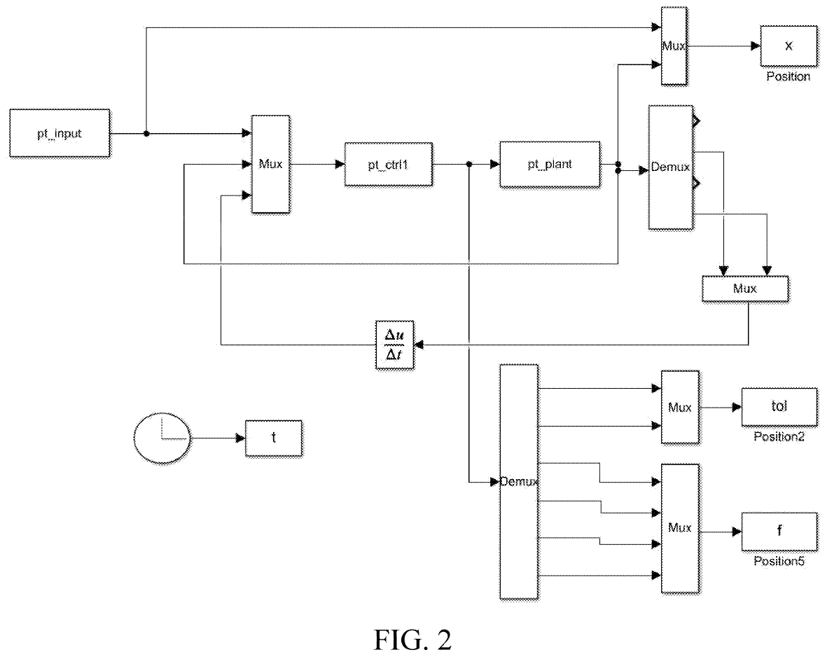

As shown in FIG. 2, a dynamic adaptive control method for a robotic manipulator under time-varying mechanism constraints via an RBF network includes a reference trajectory generator Input module, a controller Ctrl module including an error conversion, a prescribed-time RBF network disturbance approximation, and a network weight adaptive estimation module, and an actuator Plant module.

The reference trajectory generator Input module mainly generates a desired angular and a desired velocity trajectory of a control system. The controller Ctrl module mainly generates a whole system control input torque via the error conversion, the prescribed-time RBF network disturbance approximation, and the network weight adaptive estimation based on the desired angular and the desired velocity trajectory. The actuator Plant module mainly inputs a control torque into the whole robotic manipulator system to achieve stable tracking of a desired trajectory by the robotic manipulator within the prescribed time.

To verify an effectiveness of the method of the present disclosure, a simulation experiment is performed via matlab 2018b and a simulink module thereof, which is specifically as follows:

By selecting appropriate model parameters, a numerical simulation experiment of a two-degrees-of-freedom joint robotic manipulator system is constructed to verify the effectiveness of the dynamic adaptive control method for a robotic manipulator RBF network under a time-varying mechanism constraint provided by the present disclosure. Dynamics related parameters are shown in Table 1, and control parameters are shown in Table 2.

TABLE 1
Dynamic-related parameters

| Parameter | Parameter | Parameter | Parameter |
|---|---|---|---|
| Name | value | name | value |
| M₁₁ | v + q₀₁ + 2γ cos(q₂) | M₁₂ | q₀₁ + q₀₂ cos(q₂) |
| M₂₁ | q₀₁ + q₀₂ cos(q₂) | M₂₂ | q₀₁ |
| C₁₁ | −q₀₂\dot{q}₂ sin(q₂) | C₁₂ | −q₀₂(\dot{q}₁ + \dot{q}₂) sin(q₂) |
| C₂₁ | q₀₂\dot{q}₁ sin(q₂) | C₂₂ | 0 |
| G₁₁ | 15g cos q₁ + 8.75g | G₂₁ | 8.75g cos(q₁ + q₂) |
| | cos(q₁ + q₂) | | |
| v | 13.33 | q₀₁ | 8.98 |
| q₀₂ | 8.75 | g | 9.8 |

In the table, M₁₁ represents a first symmetric positive definite inertia matrix of the two-degrees-of-freedom robotic manipulator, M₁₂ represents a second symmetric positive definite inertia matrix of the two-degrees-of-freedom robotic manipulator, M₂₁ represents a third positive definite symmetric inertia matrix of the two-degrees-of-freedom robotic manipulator, and M₂₂ represents a fourth positive definite symmetric inertia matrix of the two-degrees-of-freedom robotic manipulator; C₁₁ represents a first Coriolis force of the two-degrees-of-freedom robotic manipulator, C₁₂ represents a first centrifugal force of the two-degrees-of-freedom robotic manipulator, C₂₁ represents a second Coriolis force of the two-degrees-of-freedom robotic manipulator, and C₂₂ represents a second centrifugal force of the two-degrees-of-freedom robotic manipulator; and v represents an equivalent moment of inertia of a first joint of the robotic manipulator, q₀₁ represents a moment of inertia of a second joint, q₀₂ represents a coupling inertia coefficient, and ^{g} g represents a standard value of a gravitational acceleration.

TABLE 2
Control parameters

| Parameter | Parameter | Parameter | Parameter | Parameter | Parameter |
|---|---|---|---|---|---|
| name | value | name | value | name | value |
| α | 3 | γ | 20 | k₁ | 0.01 |
| Q | Diag [50, | Cᵢ | [−2- | bᵢ | 3 |
| | 50, 50, 50] | | 1012] | | |
| μₘₐₓ | 200 | μₘᵢₙ | 50 | δ | 0.9 |

As shown in FIG. 2, α represents positive constants of a first control gain matrix

$${k}_{p} = [ \begin{matrix}{α}^{2} & 0 \\ 0 & {α}^{2}\end{matrix} ]$$

and a second design control gain matrix

$${k}_{v} = [ \begin{matrix}2 α & 0 \\ 0 & 2 α\end{matrix} ] ,$$

γ represents an adaptive learning rate, k₁ represents a design parameter, Q represents a positive definite inertia matrix, Cᵢ represents a center vector of an i-th RBF of the RBF network, bᵢ represents a width of the i-th RBF, μₘₐₓ represents an adjustment upper bound of the time-varying gain function to avoid an unbounded growth of the time-varying gain, μₘᵢₙ represents a steady-state lower limit of the time-varying gain, and & represents a safe transition interval coefficient of the time-varying gain.

A dynamics model of a two-degree-of-freedom robotic manipulator is expressed as:

$$M ( q ) \ddot{q} + C ( q , \dot{q} ) \dot{q} + G ( q ) = τ + d$$

$$where :$$

$$M ( q ) = [ \begin{matrix}{M}_{11} & {M}_{12} \\ {M}_{21} & {M}_{22}\end{matrix} ] = [ \begin{matrix}v + {q}_{01} + 2 γ cos ( {q}_{2} ) & {q}_{01} + {q}_{02} cos ( {q}_{2} ) \\ {q}_{01} + {q}_{02} cos ( {q}_{2} ) & {q}_{01}\end{matrix} ]$$

$$C ( q , \dot{q} ) = [ \begin{matrix}{C}_{11} & {C}_{12} \\ {C}_{21} & {C}_{22}\end{matrix} ] = [ \begin{matrix}{q}_{02} {\dot{q}}_{2} sin ( {q}_{2} ) & - {q}_{02} ( {\dot{q}}_{1} + {\dot{q}}_{2} ) sin ( {q}_{2} ) \\ {q}_{02} {\dot{q}}_{1} sin ( {q}_{2} ) & 0\end{matrix} ]$$

$$G ( q ) = [ \begin{matrix}{G}_{11} \\ {G}_{21}\end{matrix} ] = [ \begin{matrix}15 g cos {q}_{1} + 8.75 g cos ( {q}_{1} + {q}_{2} ) \\ 8.75 g cos ( {q}_{1} + {q}_{2} )\end{matrix} ] .$$

Assume that desired tracking commands of a joint angular and an angular velocity are:

$$\{ \begin{matrix}{q}_{1 d} & = 1 + 0.2 sin ( 0.5 π t ) \\ {q}_{2 d} & = 1 - 0.2 cos ( 0.5 π t )\end{matrix}$$

An external disturbance of the system is d=d₁+d₂∥η∥+d₃∥\dot{η}∥ where d₁=2, d₂=3, d₃=6, and an initial state of the system is [q₁ q₂ q₃ q₄]^{T}=[0.6 0.3 0.5 0.5]^{T}, where q₁, q₂, q₃, q₄ and respectively represent a first joint initial angular, a second joint initial angular, a first joint initial angular velocity, and a second joint initial angular velocity of the robotic manipulator. Assume that unmodeled dynamics of the dynamics model are ΔM=0.2M, ΔC=0.2C, ΔG=0.2G, and respectively represent that an inertia matrix has a 20% modeling error, the Coriolis force matrix has a 20% error, and a gravity compensation has a 20% deviation.

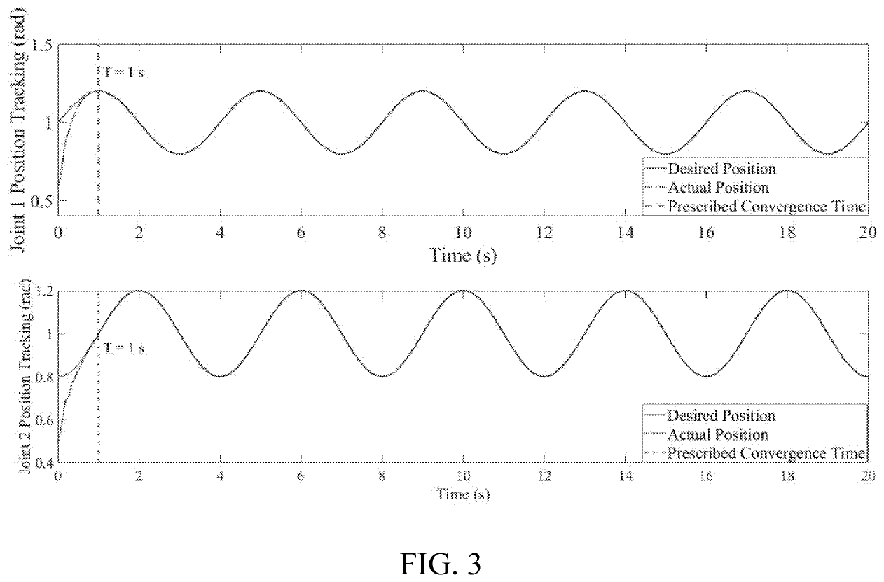

Assume that a total simulation time of the system is set to 20 s, i.e., tₜₒₜₐₗ=20s, a sampling period is Δt=0.01s, an initial weight of the RBF network is w=0.1, and the time-varying gain function p=1 and β=2. For other design parameters, refer to Table 1 and Table 2. By adopting the RBF network dynamic adaptive control law under the prescribed time provided by the present disclosure (expressed by S5), simulation results are shown in FIG. 3 to FIG. 7.

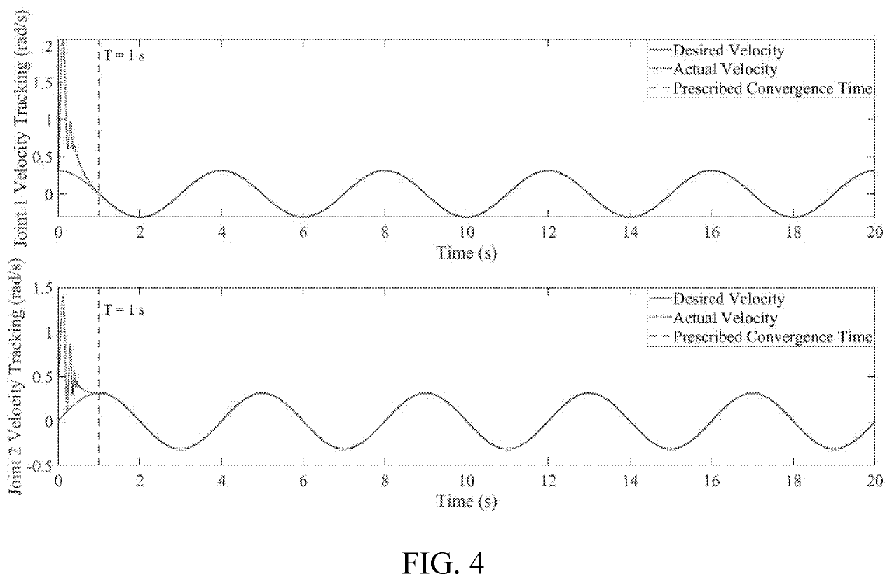

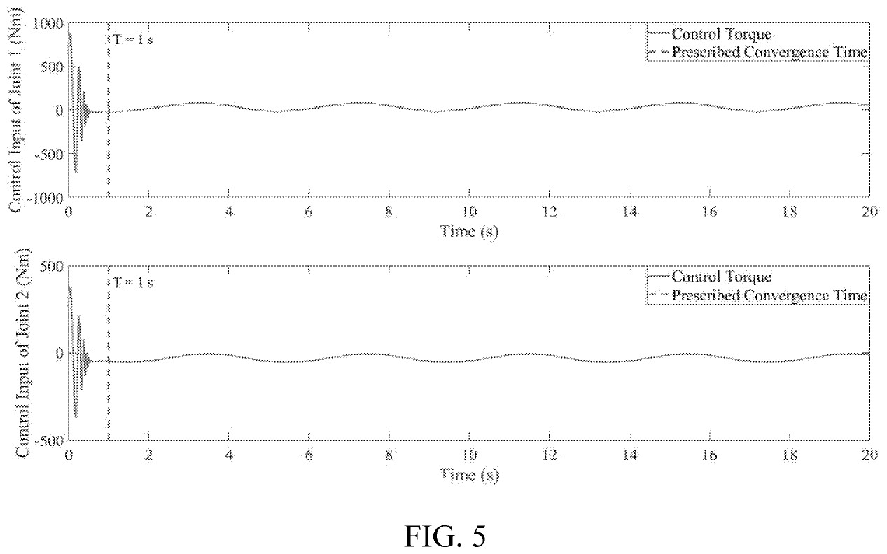

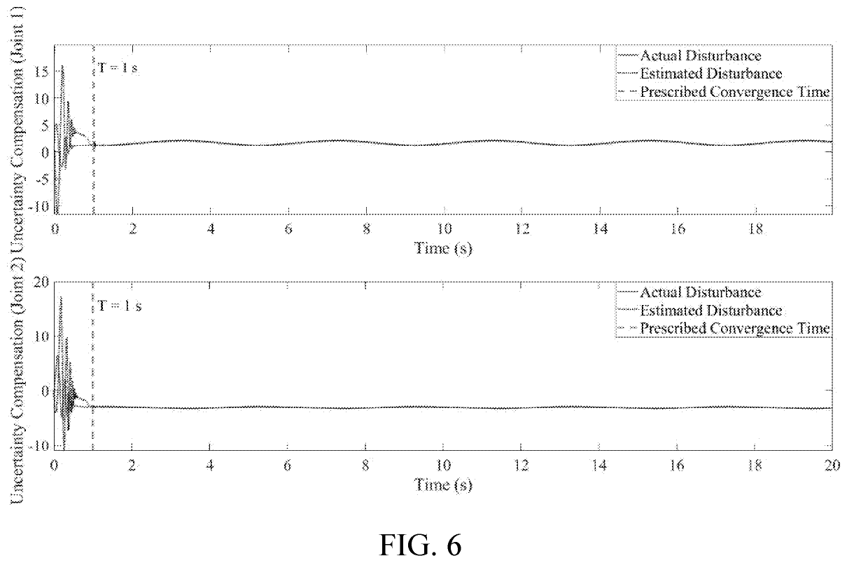

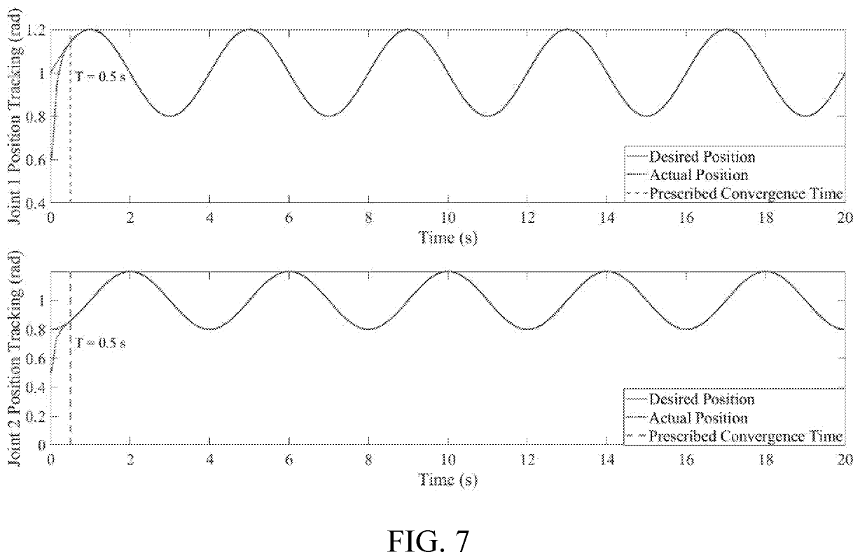

FIG. 3 and FIG. 4 respectively show a position angular and a velocity tracking error of a joint 1 and a joint 2 of the robotic manipulator. It can be clearly seen from the figures that a time-varying gain mechanism effectively bounds a fluctuation range of the errors, and an actual trajectory of the robotic manipulator joint coincides with a desired trajectory within a user defined time T=1s, which verifies a high precision and a fast response capability of the system. FIG. 5 shows a control input signal of the robotic manipulator. Under an action of an RBF network dynamic adaptive rate, it is guaranteed that the control input is stabilized within a range, and no high-frequency chattering phenomenon occurs, which verifies an engineering realizability of the algorithm. FIG. 6 shows an approximation degree of the RBF network for a nonlinear disturbance of the system. Although an initial fluctuation amplitude is large, a precise approximation within the user prescribed time is achieved through a combined action of the time-varying gain and the RBF, thereby improving a capability of coping with a dynamic disturbance in an actual working condition. As can be known from a comparison between FIG. 3 and FIG. 7, as a preset time is shortened to 0.5 s, the joint angular of the robotic manipulator can well achieve tracking within the prescribed time, which verifies the adaptability of the provided control method to a strict time constraint.

Although the embodiments of the present disclosure have been shown and described, it is to be understood by those of ordinary skill in the art that various changes, modifications, substitutions, and variations may be made to these embodiments without departing from the principle and the spirit of the present disclosure, and a scope of the present disclosure is defined by the appended claims and equivalents thereof.

1. A dynamic adaptive control method for a robotic manipulator under time-varying mechanism constraints via a radial basis function (RBF) network, comprising the steps of: constructing a robotic manipulator dynamics model, determining a system prescribed-time convergence standard, defining a trajectory tracking error in combination with a joint motion reference trajectory of the robotic manipulator, and constructing a stable robust control law of a nominal dynamics model under a prescribed time based on a dynamics nominal model, wherein: an RBF is selected, and an RBF network adaptive control law under the prescribed time is designed to dynamically fit a comprehensive nonlinear disturbance term in the system; and for a fully actuated system of an n-degree-of-freedom robotic manipulator, with unmodeled dynamics and dynamic external disturbances existing, given a joint angular q_{d} and a velocity \dot{q}_{d} reference trajectory of the robotic manipulator, stable tracking control within a user defined time T is achieved via a following controller, and a control law of the following controller is expressed as:
$$\{ \begin{matrix}{τ}_{Total} = {M}_{0} ( q ) ( {\ddot{q}}_{d} - {k}_{v} \dot{η} - {k}_{p} η ) + {C}_{0} ( q , \dot{q} ) \dot{q} + {G}_{0} ( q ) - \hat{f} ( q , \dot{q} , \ddot{q} ) \\ \hat{f} ( q , \dot{q} , \ddot{q} ) = \hat{w} \cdot h ( x ) \\ \dot{\hat{w}} = γμ ( t ) h ( x ) X \cdot PB\end{matrix}$$
where τ_{Total} represents a dynamic adaptive control law under the prescribed time of the RBF network; M₀(q) is a nominal inertia matrix of a robotic manipulator system; \ddot{q}_{d} represents a desired acceleration reference trajectory of the robotic manipulator system; kᵥ represents a second design control gain matrix; \dot{η} represents a joint velocity tracking error scaled based on a time-varying gain function; kₚ represents a first design control gain matrix; η represents a joint angular tracking error signal scaled based on the time-varying gain function; C₀(q,\dot{q}) is a nominal Coriolis force matrix of the robotic manipulator system; G₀(q) is a nominal gravity vector of the robotic manipulator system; \hat{f}(q,\dot{q},\ddot{q}) is a real-time estimated output value of an RBF for the comprehensive nonlinear disturbance term; h(x)=[h₁(x), . . . , hₘ(x)]^{T} is an output vector of the RBF; x=[q^{T},\dot{q}^{T},\ddot{q}^{T}]^{T} represents an input state vector of the RBF network; q represents a current joint angular position vector of the robotic manipulator system; \dot{q} represents a current joint motion velocity vector of the robotic manipulator system; \ddot{q} represents a current joint motion acceleration vector of the robotic manipulator system; m represents the number of nodes in a hidden layer of the RBF network; ŵ is an online estimation value of a weight of the RBF network; γ is an adaptive learning rate; X=[η,\dot{η}]^{T} is an error state vector; P is a solution matrix of a Lyapunov function; B represents an inertia matrix; and the time-varying gain function μ(t) is expressed as:
$$μ ( t ) = \{ \begin{matrix}min [ {( \frac{T}{T - t} )}^{( p + β )} , {μ}_{max} ] , & t ∈ [ 0 , δ T ] \\ {μ}_{max} [ 1 - \frac{t - δ T}{( 1 - δ ) T} ] , & t ∈ [ δ T , T ] \\ {μ}_{min} , & t ∈ [ T , + ∞ )\end{matrix}$$
where t represents time during a control process of the robotic manipulator system, δ represents a coefficient of a safe transition interval, μₘₐₓ represents an upper limit for preventing an unbounded growth of the time-varying gain function, μₘᵢₙ represents a lower limit of a stable time-varying gain, P represents an order of the robotic manipulator system, and β represents a positive design parameter.

2. The method according to claim 1, wherein when calculating the RBF network dynamic adaptive control law under the prescribed time, an approximation error of the RBF network for the comprehensive nonlinear disturbance term is less than or equal to a supremum of the approximation error of the RBF network for the comprehensive nonlinear disturbance term, and the approximation error of the RBF network for the comprehensive nonlinear disturbance term is:
σ(x)=f(q,\dot{q},\ddot{q})−w*^{T}h(x)
where σ(x) is an approximation error of the RBF network for the comprehensive nonlinear disturbance term; f(q,\dot{q},\ddot{q}) is the comprehensive nonlinear disturbance term, expressed as f(q,\dot{q},\ddot{q})=ΔM\dot{q}+ΔC\dot{q}+ΔG+d, ΔM represents inertia parameter uncertainty of the robotic manipulator system, ΔC represents a modeling error of a Coriolis force matrix of the robotic manipulator system, ΔG represents a gravity compensation residual of the robotic manipulator system, and d is an unknown external environment disturbance vector; and w* represents an ideal weight of the RBF network.

3. The method according to claim 1, wherein calculating the error state vector comprises:
$$η ( t ) = μ ( t ) e ( t )$$
$$\dot{η} = μ ( t ) \dot{e} ( t ) + \frac{\dot{μ} ( t )}{μ ( t )} η ( t )$$
where η(t) is a joint angular tracking error scaled based on the time-varying gain function at a moment t, and e(t) is an error between an actual joint angular trajectory at the moment t and a desired joint angular trajectory at the moment t; \dot{η}(t) is a joint velocity tracking error scaled based on the time-varying gain function at the moment t; and ė(t) is a difference between an actual joint velocity trajectory at the moment t and a desired joint velocity trajectory at the moment t, and \dot{μ}(t) is a derivative of the time-varying gain function with respect to time.

4. The method according to claim 1, wherein a solution matrix P of a Lyapunov function satisfies the following condition:
A^{T}P+PA=−Q
where
$$A = [ \begin{matrix}0 & {I}_{n} \\ - {k}_{p} & - {k}_{v}\end{matrix} ]$$
represents a design control gain parameter matrix, Iₙ represents an n-n-dimensional identity matrix, and Q represents a positive definite symmetric matrix.

5. The method according to claim 1, wherein the first design control gain matrix is expressed as
$${k}_{p} = [ \begin{matrix}{α}^{2} & 0 \\ 0 & {α}^{2}\end{matrix} ] ;$$
and the second design control gain matrix is expressed as
$${k}_{v} = [ \begin{matrix}2 α & 0 \\ 0 & 2 α\end{matrix} ] ,$$
and α is a positive design constant.

6. The method according to claim 4, wherein the first design control gain matrix is expressed as
$${k}_{p} = [ \begin{matrix}{α}^{2} & 0 \\ 0 & {α}^{2}\end{matrix} ] ;$$
and the second design control gain matrix is expressed as
$${k}_{v} = [ \begin{matrix}2 α & 0 \\ 0 & 2 α\end{matrix} ] ,$$
and α is a positive design constant.

7. The method according to claim 1, wherein when a preset convergence time is T, a system Lyapunov function is bounded on a region [0,T), and a prescribed-time convergence criterion is:
$$\dot{V} ( t ) \leq - 2 k μ ( t ) V ( t ) + \frac{μ ( t )}{4 θ} {d ( t )}^{2}$$
where \dot{V}(t) represents a derivative of the system Lyapunov function with respect to time; k and θ are positive constants, V(t) represents the system Lyapunov function; and d(t) represents an unknown disturbance of the system.

8. The method according to claim 1, wherein a dynamics model of the n-degree-of-freedom robotic manipulator is expressed as:
M(q)\ddot{q}+C(q,\dot{q})\dot{q}+G(q)=τ+d
where M(q)∈ [symbol] ^{n×n} is a positive definite inertia matrix; C(q,\dot{q})∈ [symbol] ^{n×n} is a Coriolis force matrix; G(q)∈ [symbol] ⁿ is a gravity vector; d is an unknown external environment disturbance vector; and τ∈ [symbol] ⁿ is an input torque of a joint.
